(19) United States
(12) Patent Application Publication
(10) Pub. No.: US 2007/0201310 A1
(43) Pub. Date: Aug. 30, 2007

(54) Reminder system relating to application and usage of a product applied to the body

(76) Inventor: Steven L. Weiner, Alamo, CA (US)

Correspondence Address: THOMAS R. LAMPE;BIELEN, LAMPE & THOEMING, 1390 WILLOW PASS ROAD, SUITE 1020, CONCORD, CA, 94520, US

(21) Appl. No.: 11/434,955

(22) Filed: May 16, 2006

Related U.S. Application Data
(60) Provisional application No. 60/683,122, filed on May 17, 2005.

(51) Int. Cl. G04B 47/00

(52) U.S. Cl. 368/10

(57) ABSTRACT

A timer cap is movable relative to a container holding a product to be applied to the skin, hair or other body part. Programs in a control microprocessor in the timer cap are actuated by opening and closing the container by the timer cap to initiate different programs relating to the time periods associated with application and usage of the product.

This Application is based on and claims the benefit of U.S. Provisional Patent Application Ser. No. 60/683,122, filed May 17, 2005.

### TECHNICAL FIELD

This invention relates to an apparatus for reminding an individual regarding application and usage of a product applied to skin, hair or other body part.

### BACKGROUND OF THE INVENTION

My U.S. Pat. No. 6,545,592, issued Apr. 8, 2003, relates to a medication reminder device employing a cap unit associated with a container for storing pills. The cap unit has a timer dial and an alarm activated after passage of a set time to remind an individual that it is time to take his or her medication.

The invention of the present invention relates to an apparatus and method for reminding an individual regarding application and usage of a product applied to the skin, hair or other body part.

Many products, such as medicated and non-medicated skin and hair care products, are available in the marketplace. Often such products are time sensitive, both as to application and retention on the hair, skin or the like. For example, chemical burns can result from prolonged application or retention on the skin of chemical peels. Hair products, such as hair color products, can damage the hair if applied and maintained in contact with the hair for too long a period. For example, hair can be discolored, made brittle or otherwise damaged by overuse. And of course, it is always advisable to strictly follow the directions provided for any product applied to the skin or hair to obtain the desired results. Unfortunately, many people do not follow printed instructions enclosed with the products or even read them. If the instructions are read, users often lose track of time. It is known to provide separate timers with certain products, but consumers often forget to use them or use them improperly.

### DISCLOSURE OF INVENTION

The present invention encompasses apparatus for reminding an individual regarding application and usage of a product applied to skin, hair or other body part. This is accomplished virtually automatically. The apparatus includes a container having a container interior containing the product and defining an opening in communication with the container interior.

A timer cap is movable relative to the container to selectively alternatively open the container opening or close the container opening.

The timer cap includes a control microprocessor programmed with a plurality of programs relating to application and usage of the product in the container. The control microprocessor is responsive to movement of the timer cap relative to the container to open the container opening and to movement of the timer cap relative to the container to close the container opening to initiate operation of different alternative programs of the plurality of programs.

Signal structure is controlled by the control microprocessor signaling the individual with respect to time periods associated with the application and usage of the product relating to the plurality of programs.

The invention also encompasses a method for reminding an individual regarding application and usage of a product applied to the skin, hair or other body part, the product being disposed in the interior of a container defining a container opening in communication with the interior.

According to the method, a control microprocessor programmed with a plurality of programs relating to application and usage of the product in the container is incorporated in a timer cap.

The method also includes the step of initiating operation of different alternative programs of the plurality of programs by selectively alternatively employing the timer cap to open the container opening and close the container opening.

Signal structure is employed in the timer cap controlled by the control microprocessor to signal the individual with respect to time periods associated with application and usage of the product relating to the plurality of programs.

Other features, advantages and objects of the present invention will become apparent with reference to the following description and accompanying drawings.

### BRIEF DESCRIPTION OF DRAWINGS

FIG. 1 is a frontal, perspective view of a first embodiment of apparatus constructed in accordance with the teachings of the present invention with the container and timer cap thereof connected together;

FIG. 2 is a view similar to FIG. 1, but showing the container and timer cap separated;

FIG. 3 is a top, perspective view of the timer cap showing an actuator button of an internal switch disposed in the interior of the timer cap;

FIG. 4 is a bottom, perspective view of the timer cap;

FIG. 5 is a view similar to FIG. 1, but illustrating a second embodiment of the invention;

FIG. 6 is a view similar to FIG. 1, but illustrating a third embodiment of the invention;

FIG. 7 is a block diagram illustrating components employed in a timer cap constructed in accordance with the teachings of the present invention; and

FIG. 8 is a flow diagram illustrating sequential steps carried out by a programmed control microprocessor employed in the timer cap.

### MODES FOR CARRYING OUT THE INVENTION

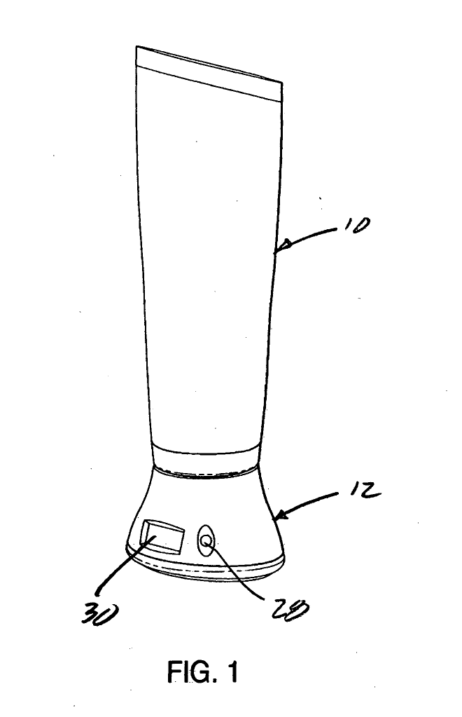

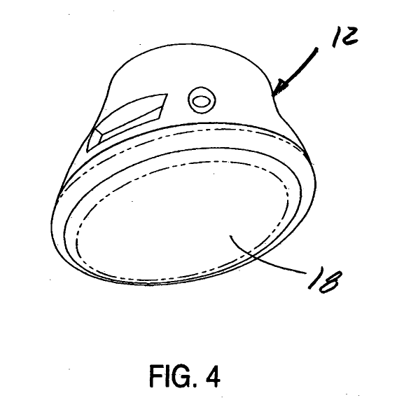

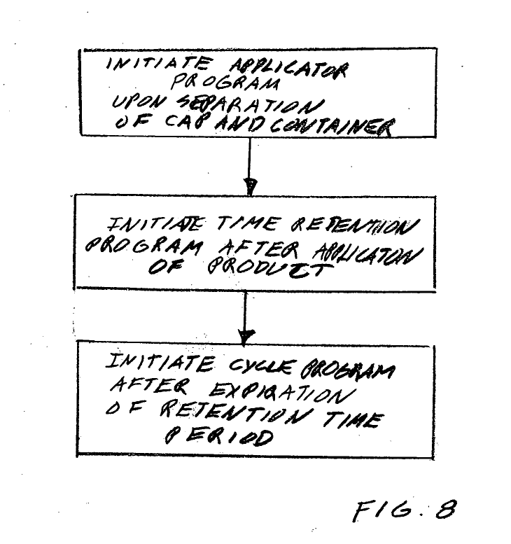

Referring now to FIGS. 1-4, 7 and 8, an embodiment of apparatus constructed in accordance with the teachings of the present invention is disclosed.

The apparatus is for reminding an individual regarding application and usage of a product applied to skin, hair or other body part.

The apparatus includes a container 10 and a timer cap 12. In this embodiment of the invention, the container is in the form of a standard squeeze tube having a container interior containing the product and defining an opening at one end of the tube in communication with the interior. Threads 14 at the open end of the container cooperate with threads 16 of the timer cap 12 to maintain a releasable connection between the container and the timer cap.

In practice, the product would normally be sold to the consumer in a package with the timer cap and container secured together as shown in FIG. 1.

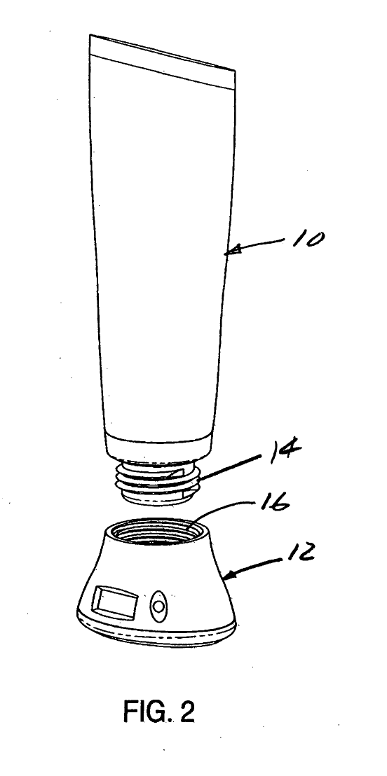

In the embodiment under discussion, the timer cap not only protects the product but also functions as a support for the container, the bottom 18 of the timer cap being flat so that it can be readily positioned in a stable manner on a counter or other flat surface. The timer cap is selectively alternatively connectable by the user to the container adjacent to the container opening at the open end of the container or disconnectable from the container, the latter condition being shown in FIG. 2 for example. That is, the timer cap is movable relative to the container to selectively alternatively open the container opening and close the container opening.

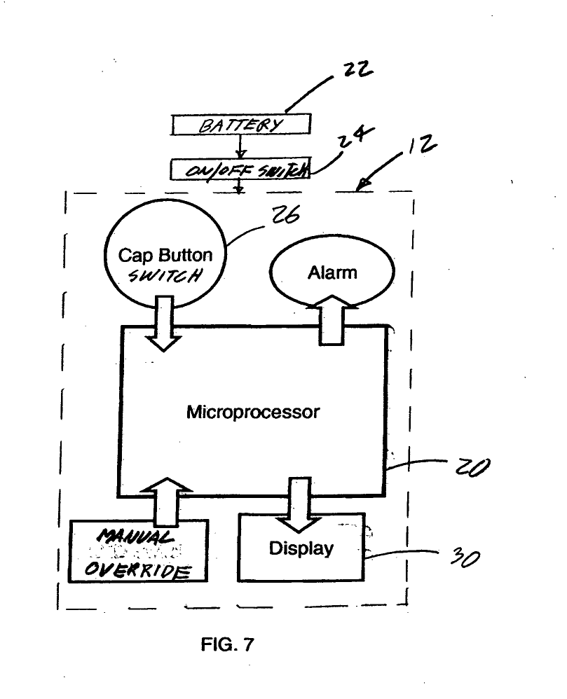

The timer cap 12 includes a control microprocessor 20 (FIG. 7) programmed with a plurality of programs relating to application and usage of the product in the container. The microprocessor and other electrically powered components of the timer cap 12 are powered by a battery 22, a conventional external on/off switch 24 optionally being utilized to provide electrical communication between the battery and the electrically operated components of the timer cap.

The control microprocessor 20 is preprogrammed with a plurality of programs relating to application and usage of the product in the container. These programs will be described below. The control microprocessor is responsive to movement of the timer cap relative to the container to close the container opening and to movement of the timer cap relative to the container to open the container opening to initiate operation of different alternative programs of the plurality of programs.

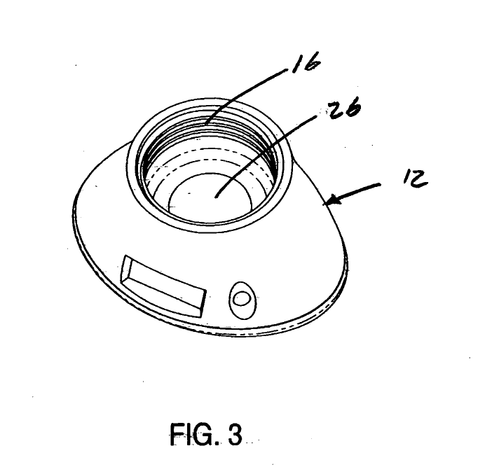

As indicated above, the container and timer cap are normally initially provided to the consumer in a package in which the timer cap and container are screwed together as shown in FIG. 1. Assuming that optional on/off switch 24 is in its on position and the timer cap components are operatively associated with battery 22, unscrewing of the timer cap from the container will initiate an applicator program preprogrammed into the microprocessor. This is accomplished by an internal switch in the cap which closes when the cap and container are separated. More particularly, the switch incorporates a cap button designated by reference numeral 26 in FIG. 3. When the container and timer cap are screwed together, the cap button of the internal switch 26 is depressed and maintained in off position due to engagement of the open end of the container with the cap button.

Upon unscrewing of the timer cap, i.e. opening of the container opening, the cap button will move upwardly under the influence of an internal biasing member such as a compression spring (not shown) to close the internal switch and thus initiate operation of an applicator program preprogrammed into the microprocessor. Closure of the internal switch also turns on timer cap signal structure including an LED 28 signifying that the applicator program has been initiated and LCD 30. The applicator program relates to an application time period for applying the product to the skin, hair or other body part. The LCD display counts down a predetermined set amount of time for the product to be applied to the user, such time being established by the manufacturer of the product. At the end of the count-down when the time left in the application time period has expired, an alarm is provided. This can, for example, be a sound alarm, a light alarm or both. Flashing of the LCD or LED could constitute the light alarm.

After the product has been dispensed and applied to the skin, hair, etc., the timer cap and container are threaded together and reattached. That is, the timer cap closes the container opening. The cap button of the internal switch 26 is once again depressed by the threaded end of the container, a condition which causes a second program of the microprocessor, a retention time program, to be initiated. Also, if any time remains in the application time period, the operation of the applicator program will be terminated. The retention time program relates to a retention time period after the application time period for retaining the applied product on the skin, hair or other body part. When the retention time period elapses, an alarm in the nature of an audio alarm, a visual alarm, or a combination of the two will so advise the individual using the product whereby the product may be removed in a timely manner. The alarm, may, for example, be in the order of about one minute, and then the timer will shut down. The timer cap may incorporate an override feature enabling the user to adjust programmed time periods. For example, length of time may be shortened to adapt to more sensitive skin or hair.

The control microprocessor 20 is programmed to go into a rest mode wherein alarms and displays are turned off while the control microprocessor initiates running of a cycle program relating to a cycle time period after the retention time period counting down a preset time period until the next product application is due. This could be, for example, a week or whatever length of time the manufacturer specifies for additional applications. At the end of this period, the signal structure of the cap timer will be actuated to provide an alarm at the end of the cycle time period. Suitably, for example upon completing the count down between applications, the timer may initiate a beep alarm and flash the LED display to remind the user that it is time to do another application. When the user opens the timer cap to begin the next application, the applicator program will again be initiated and the sequence of programs and events will start over again.

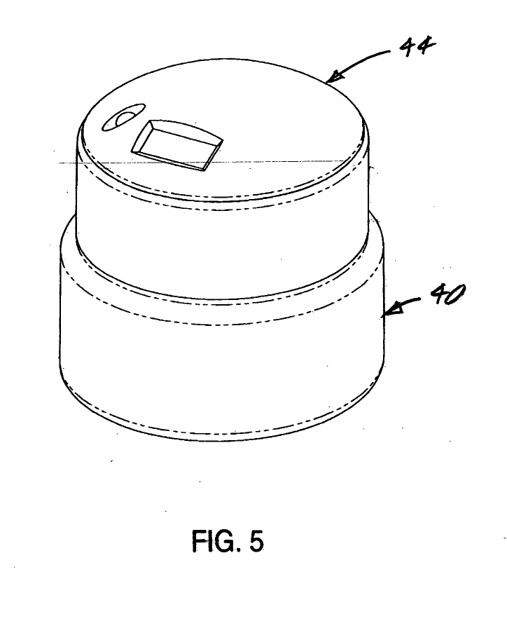

FIG. 5 shows a second embodiment of the invention wherein the container is in the form of a jar 40, the timer cap 42 being in the form of a lid 44 releasably secured to the jar by any suitable expedient such as threads.

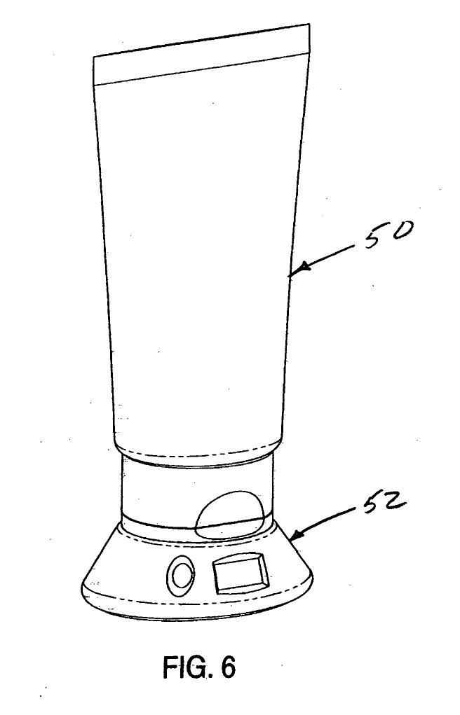

The third embodiment of the invention in FIG. 6 is similar to the embodiment of FIG. 1, the container 50 and timer cap 52 being larger than and having different configurations than those structural elements in the FIG. 1 embodiment.

Other variations of the invention are possible as well. For example, all or a portion of the timer cap can be pivotally attached to the container by a hinge or slidably connected to the container, and the timer cap can be operated responsive to opening or closing.

The invention claimed is:

1. Apparatus for reminding an individual regarding application and usage of a product applied to skin, hair or other body part, said apparatus comprising, in combination:
a container having a container interior containing the product and defining a container opening in communication with the container interior; and
a timer cap having at least a portion thereof selectively alternatively movable relative to the container to open said container opening or close said container opening, said timer cap including a control microprocessor programmed with a plurality of programs relating to application and usage of the product in said container, said control microprocessor responsive to movement of at least a portion of said timer cap relative to said container to open said container opening and to movement of at least a portion of said timer cap relative to said container to close said container opening to initiate operation of different alternative programs of said plurality of programs, and signal structure controlled by said control microprocessor signaling the individual with respect to time periods associated with application and usage of the product relating to said plurality of programs.

2. The apparatus according to claim 1 wherein said timer cap additionally includes sensing structure for sensing when said timer cap opens said container opening and when said said timer cap closes said container opening, said sensing structure being operatively associated with said control microprocessor to initiate operation of said different alternative programs.

3. The apparatus according to claim 2 wherein said sensing structure comprises a switch movable between an open condition and a closed condition responsive to relative movement between said timer cap and said container.

4. The apparatus according to claim 3 wherein said switch includes a moveable switch member engageable by said container adjacent to said opening when said timer cap closes said container opening.

5. The apparatus according to claim 1 wherein said signal structure includes a light alarm.

6. The apparatus according to claim 1 wherein said signal structure includes a sound alarm.

7. The apparatus according to claim 1 wherein said signal structure includes a display indicating time remaining in said time periods.

8. The apparatus according to claim 1 wherein said container is a flexible dispenser tube.

9. The apparatus according to claim 1 wherein said container is a jar.

10. The apparatus according to claim 1 wherein one of said programs is an applicator program relating to an application time period for applying said product to the skin, hair or other body part, said signal structure notifying the individual of the time remaining in the application time period and providing an alarm at the end of the application time period.

11. The apparatus according to claim 10 wherein one of said programs is a retention time program relating to a retention time period after said application time period for retaining the applied product on the skin, hair or other body part, said signal structure notifying the individual of the time remaining in the retention time period and providing an alarm at the end of the retention time period.

12. The apparatus according to claim 11 wherein one of said programs is a cycle program relating to a cycle time period after said retention time period counting down a preset time period until the next product application is due, said signal structure notifying the individual of the time remaining in the cycle time period and providing an alarm at the end of the cycle time period.

13. The apparatus according to claim 1 wherein said timer cap comprises a support for said container.

14. A method for reminding an individual regarding application and usage of a product applied to the skin, hair or other body part, the product being disposed in the interior of a container defining a container opening in communication with said interior, said method comprising the steps of:
incorporating in a timer cap a control microprocessor programmed with a plurality of programs relating to application and usage of the product in said container;
initiating operation of different alternative programs of said plurality of programs by selectively alternatively employing said timer cap to open said container opening and close said container opening; and
employing signal structure in said timer cap controlled by said control microprocessor to signal the individual with respect to time periods associated with application and usage of the product relating to said plurality of programs.

15. The method according to claim 14 wherein one of the programs programmed into said control microprocessor is an applicator program relating to an application time period for applying product to the hair, skin or other body part, said method including the step of employing said signal structure to notify the individual of the time remaining in the application time period and provide an alarm at the end of the application time period.

16. The method according to claim 15 wherein said application time period is initiated by moving at least a portion of said timer cap relative to said container to open said container opening.

17. The method according to claim 15 wherein one of the programs programmed into said control microprocessor is a retention time program relating to a retention time period initiated after said application time period for retaining the product applied during said application period to the hair, skin or other body part, the method including the step of employing said signal structure to notify the individual of the time remaining in the retention time period and providing an alarm at the end of the retention time period.

18. The method according to claim 17 wherein said retention time period is initiated by moving at least a portion of said timer cap relative to said container to close said container opening.

19. The method according to claim 18 wherein the step of moving at least a portion of said timer cap relative to said container to close said container opening is also operable to terminate operation of the applicator program if the application time period has not yet expired.

20. The method according to claim 17 wherein one of said programs is a cycle program relating to a cycle time period until the next product application is due, said cycle time period being initiated after termination of said retention time period, and said method including the steps of notifying the individual of the time remaining in the cycle time period and providing an alarm at the end of the cycle time period.
